(19) United States
(12) Patent Application Publication
(10) Pub. No.: US 2025/0141746 A1
(43) Pub. Date: May 1, 2025

(54) METHOD OF PROVIDING MULTI-TRANSMISSION PATH SERVICE ON CLOUD VIRTUAL NETWORK AND APPARATUS FOR IMPLEMENTING THE METHOD

(71) Applicant: SAMSUNG SDS CO., LTD., Seoul (KR)

(72) Inventors: Seon Ok PARK, Seoul (KR); Hyun Min JUNG, Seoul (KR); Byung Hyun CHO, Seoul (KR); Seung Je LEE, Seoul (KR); Si Hun SONG, Seoul (KR); Tae Kyoung SON, Seoul (KR); Kyu CHOI, Seoul (KR); Yong Ho KIM, Seoul (KR); Ji Hee SUH, Seoul (KR); Dong Mun YANG, Seoul (KR); Jang Myoung LEE, Seoul (KR); Seung Ki KIM, Seoul (KR); Kyoung Ho SEO, Seoul (KR); Ji Young YOON, Seoul (KR); Jin Yong PARK, Seoul (KR); Won Ho NA, Seoul (KR)

(73) Assignee: Samsung SDS Tower, Seoul (KR)

(21) Appl. No.: 18/929,042

(22) Filed: Oct. 28, 2024

(30) Foreign Application Priority Data
Oct. 30, 2023 (KR) 10-2023-0146740

(51) Int. Cl. H04L 41/0895; H04L 41/0894; H04L 41/5006

(52) U.S. Cl. CPC H04L 41/0895; H04L 41/0894; H04L 41/5006

(57) ABSTRACT

The present disclosure according to at least one embodiment provides a method of providing a multi-transmission path service on a cloud virtual network, the method being performed by a computing system. The method includes creating a customer-dedicated virtual network domain based on user input, setting a multi-transmission path policy for the virtual network domain, and completing service configuration of the virtual network domain by specifying a section to which the multi-transmission path policy is to be applied

This application claims the benefit of Korean Patent Application No. 10-2023-0146740, filed on Oct. 30, 2023, in the Korean Intellectual Property Office, the disclosure of which is incorporated herein in its entirety by reference.

### BACKGROUND

### 1. Field

The present disclosure relates to a method of providing a multi-transmission path service on a cloud virtual network and an apparatus for implementing the method, and more particularly, to a method of providing a multi-transmission path service on a cloud virtual network, the method being employed to transmit user traffic using multiple transmission paths on a cloud virtual network, and an apparatus for implementing the method.

### 2. Description of the Related Art

In a typical network service based on multi-protocol label switching (MPLS) technology, virtual routing forwarding (VRF) for each customer may be distinguished as a virtual network domain. Cloud service providers are providing cloud network services using this network virtual routing technology, but there is a growing demand for a differentiated network transmission path for each service even within a customer domain.

A differentiated transmission path for each service can be implemented using standard traffic engineering technologies such as resource reservation protocol (RSVP) and segment-routing. However, since an interface where customer routing information (VRF) is input must be distinguished, a routing path for each VRF may be adjusted after physical work or VRF separation work at the customer end. In addition, manual settings need to be made by logging into individual equipment or through an equipment manager.

Most cloud service providers do not provide a differentiated transmission path for each service. Some cloud service providers provide network rating services to improve the quality of Internet hosting and content delivery network (CDN) services. However, these are limited to public clouds that must use public IP addresses, and when an object such as a virtual module is created within a cloud such as a virtual machine (VM), it can only be used if directly mapped to a network service level.

However, even when connecting to private clouds and non-cloud on-premise sites and legacy servers, it is required to provide a differentiated traffic transmission path for each service and adjust and control a transmission path for each application that a user needs.

In addition, there is a need for a method that allows a user to change to a desired location and transmission path by considering traffic usage or service quality not only when opening and creating a network service but also while using a network service.

### SUMMARY

Aspects of the present disclosure provide a method of providing a multi-transmission path service on a cloud virtual network, the method being employed to remotely configure multiple transmission paths for transmitting traffic only by setting software without physical changes to an interface when configuring a virtual network domain (VRF) for each customer or purpose on a cloud virtual network, and an apparatus for implementing the method.

Aspects of the present disclosure also provide a method of providing a multi-transmission path service on a cloud virtual network, the method being employed to set a different traffic transmission path for each application when configuring a virtual network domain (VRF) for each customer or purpose on a cloud virtual network, and an apparatus for implementing the method.

Aspects of the present disclosure also provide a method of providing a multi-transmission path service on a cloud virtual network, the method being employed to configure an intelligent multi-transmission path based on automatic settings or an AI model using a traffic usage and application quality when configuring a virtual network domain (VRF) for each customer or purpose on a cloud virtual network, and an apparatus for implementing the method.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, there is provided a method of providing a multi-transmission path service on a cloud virtual network, the method being performed by a computing system. The method comprises creating a customer-dedicated virtual network domain based on user input, setting a multi-transmission path policy for the virtual network domain, and completing service configuration of the virtual network domain by specifying a section to which the multi-transmission path policy is to be applied.

In some embodiments, the creating of the customer-dedicated virtual network domain may comprise receiving input for selecting a region to which the virtual network domain is to be applied.

In some embodiments, the setting of the multi-transmission path policy for the virtual network domain may comprise setting a transmission path for each application for the virtual network domain.

In some embodiments, the transmission path may be configured as a line of a different quality depending on at least one of a dedicated line, an Internet line, a speed, a duplexing, and a telecommunications service provider.

In some embodiments, the setting of the multi-transmission path policy for the virtual network domain may comprise selecting any one of a plurality of service contract types for the virtual network domain, and setting a default path to a high-quality line and setting an exception path to a medium-quality line if the selected service contract type is a premium service.

In some embodiments, the setting of the multi-transmission path policy for the virtual network domain may comprise selecting any one of a plurality of service contract types for the virtual network domain, and setting a default path to a medium-quality line and setting an exception path to a high-quality line if the selected service contract type is a standard service.

In some embodiments, the setting of the multi-transmission path policy for the virtual network domain may comprise selecting any one of a plurality of service contract types for the virtual network domain, and setting a default path to a normal-quality line and setting an exception path to a high-quality line or a medium-quality line if the selected service contract type is a light service.

In some embodiments, the default path may be automatically set using line information preset for the selected service contract type, and the exception path may be set based on input for selecting at least one of source IP information, destination IP information, port information, protocol type, and location information of an application.

In some embodiments, the high-quality line may be a dedicated optical cable, the medium-quality line may be a dedicated line of a telecommunications service provider, and the normal-quality line may be an Internet line of a telecommunications service provider.

In some embodiments, the method may further comprise measuring a usage of traffic for each transmission path transmitted according to the multi-transmission path policy set for the virtual network domain.

In some embodiments, the method may further comprise performing billing based on a traffic usage measured for each transmission path.

In some embodiments, the setting of the multi-transmission path policy for the virtual network domain may comprise setting a line applied to each transmission path by time based on a usage of traffic transmitted through each transmission path by time.

In some embodiments, the setting of the multi-transmission path policy for the virtual network domain may comprise setting a detour to a second base with a low traffic usage to be made in response to a traffic usage increasing to or above a threshold at a first base on each transmission path.

In some embodiments, the setting of the multi-transmission path policy for the virtual network domain may comprise setting a detour to a fourth base, which is safe from a security attack, to be made in response to the security attack being detected at a third base on each transmission path.

In some embodiments, the setting of the multi-transmission path policy for the virtual network domain may comprise setting a line applied to a specific application to be automatically changed in response to a response speed of the specific application being detected to be equal to or lower than a preset reference value.

In some embodiments, the setting of the multi-transmission path policy for the virtual network domain may comprise extracting location information, IP information and port information of a specific application based on a generative AI model using service analysis data associated with the specific application, and creating an input rule for setting a transmission path of the specific application using the extracted information.

In some embodiments, the setting of the multi-transmission path policy for the virtual network domain may comprise creating a rule based on an AI model to delete a first transmission path and use a second transmission path in response to traffic usage for the first transmission path applied to a specific application exceeding a preset upper limit.

In some embodiments, the setting of the multi-transmission path policy for the virtual network domain may comprise calculating a shortest path for a specific application and resetting a transmission path in response to a failure of at least one of a base, equipment, and line of the transmission path applied to the specific application.

According to another aspect of the present disclosure, there is provided a cloud virtual network management apparatus. The apparatus comprises one or more processors, a memory loading a computer program to be executed by the one or more processors, and a storage storing the computer program, wherein the computer program comprises instructions for performing an operation of creating a customer-dedicated virtual network domain based on user input, an operation of setting a multi-transmission path policy for the virtual network domain, and an operation of completing service configuration of the virtual network domain by specifying a section to which the multi-transmission path policy is to be applied.

In some embodiments, the operation of setting the multi-transmission path policy for the virtual network domain may comprise an operation of setting a transmission path for each application for the virtual network domain, and the transmission path may be configured as a line of different quality depending on at least one of a dedicated line, an Internet line, speed, duplexing, and a telecommunications service provider.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates the configuration of a system for cloud virtual network management according to an embodiment of the present disclosure;

FIG. 2 is a flowchart illustrating a method of providing a multi-transmission path service on a cloud virtual network according to an embodiment of the present disclosure;

FIG. 3 is a flowchart illustrating a detailed process of an operation illustrated in FIG. 2;

FIG. 4 is a flowchart illustrating operations additionally performed after operations illustrated in FIG. 2;

FIG. 5 is a conceptual diagram illustrating provision of a multi-transmission path service according to embodiments of the present disclosure;

FIG. 6 is an example of a network configuration for setting multiple transmission paths according to embodiments of the present disclosure;

FIG. 7 is an example of equipment settings according to the network configuration for providing multiple transmission paths illustrated in FIG. 6;

FIG. 8 is an example of transmitting traffic using a different transmission path for each application according to embodiments of the present disclosure;

FIG. 9 is an example of applying an intelligent transmission path change policy based on traffic usage and service quality according to embodiments of the present disclosure;

FIG. 10 is an example of a user interface for entering a multi-transmission path policy according to embodiments of the present disclosure;

FIG. 11 is an example of a rule list generated according to an input multi-transmission path policy according to embodiments of the present disclosure; and

FIG. 12 illustrates the hardware configuration of an exemplary computing system capable of implementing methods according to an embodiment of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

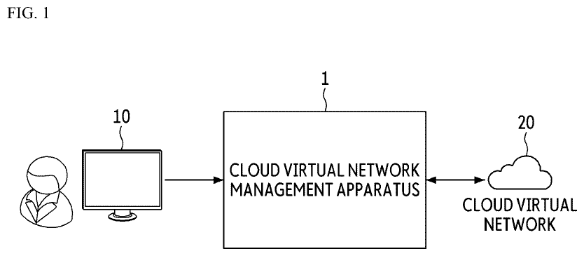

FIG. 1 illustrates the configuration of a system for cloud virtual network management according to an embodiment of the present disclosure.

Referring to FIG. 1, the system according to the embodiment of the present disclosure includes a cloud virtual network management apparatus 1 and a user terminal 10.

The cloud virtual network management apparatus 1 creates a virtual network domain (virtual routing forwarding (VRF)) for each customer or purpose on a cloud virtual network 20 according to a request from the user terminal 10.

As an example, the cloud virtual network management apparatus 1 may create a virtual network domain for each customer or purpose based on input through a user console screen accessed from the user terminal 10. Here, when a user selects a service menu displayed on the user console screen and inputs a name of a segment, one customer-dedicated virtual network domain (VRF) corresponding to the name of the segment may be set in network equipment. That is, a segment refers to a service name input by a customer through a console screen to create a customer-dedicated virtual network domain. Next, a region or equipment name to which the virtual network domain is to be applied may be selected. Accordingly, the configuration of the customer-dedicated virtual network domain to be applied to the region may be completed.

Next, when a rule of a multi-transmission path policy is input through the user console screen accessed from the user terminal 10, the cloud virtual network management apparatus 1 applies the input rule of the multi-transmission path policy to the customer-dedicated virtual network domain.

As an embodiment, a different traffic transmission path may be set for each application according to the input rule of the multi-transmission path policy. Here, the traffic transmission path may be configured as a line of different quality depending on at least one of a dedicated line, an Internet line, speed, duplexing, and a telecommunications service provider.

As an example, according to the rule of the multi-transmission path policy input for the customer-dedicated virtual network domain, a traffic transmission path for a first application may be set to a dedicated optical cable, and a traffic transmission path for a second application may be set to a dedicated line of a telecommunications service provider.

In addition, when the rule of the multi-transmission path policy is input, IP information, protocol information and port information of an application for a transmitter and a receiver may be included.

Finally, the cloud virtual network management apparatus 1 may complete service configuration of the customer-dedicated virtual network domain by specifying a section (e.g., a network backbone for service and a customer equipment or site) to which the multi-transmission path policy for the customer-dedicated virtual network domain is to be applied.

According to the above configuration of the system according to the present disclosure, when a virtual network domain (VRF) for each customer or purpose is configured on a cloud virtual network, multiple transmission paths for transmitting traffic can be remotely configured without physical network separation work. Accordingly, since a traffic transmission path can be adjusted for each application, a user can set the transmission path to a desired line by considering the importance of each application, traffic usage, and required network quality.

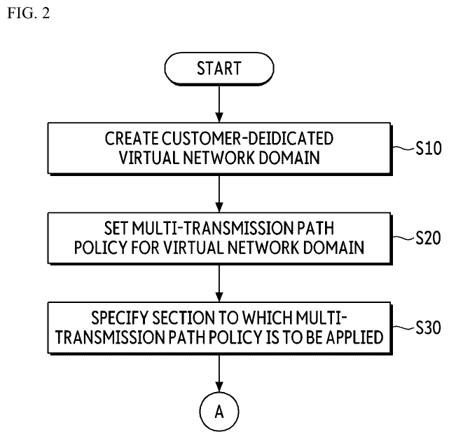

FIG. 2 is a flowchart illustrating a method of providing a multi-transmission path service on a cloud virtual network according to an embodiment of the present disclosure.

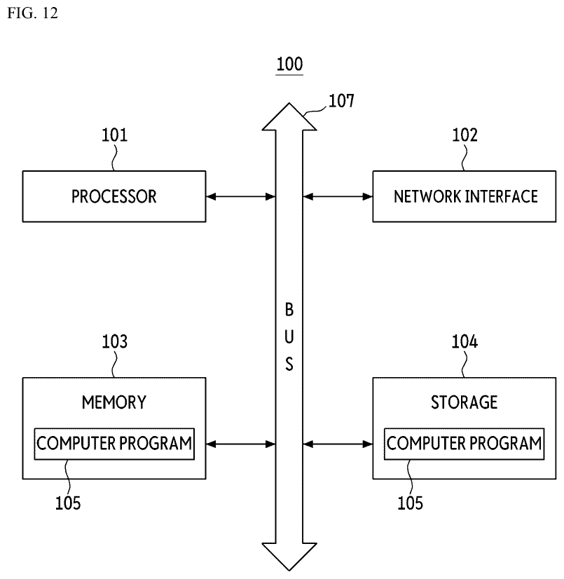

The method of providing the multi-transmission path service according to the embodiment of the present disclosure may be executed by the cloud virtual network management apparatus 1 illustrated in FIG. 1 or a computing system 100 illustrated in FIG. 12. The computing system 100 executing the method according to the present disclosure may be a computing device equipped with an application program execution environment. The computing system 100 may be composed of at least one device that can perform a computational function, such as a PC or a server.

It should be noted that a subject performing some operations included in the method according to the embodiment of the present disclosure may be omitted, and in such a case, the subject is the computing system 100.

According to the embodiment of the present disclosure described below, when a virtual network domain (VRF) for each customer or purpose is configured on a cloud virtual network, a different transmission path may be set for each application according to a service level. Therefore, a differentiated cloud service can be provided.

First, in operation S10, the computing system 100 creates a customer-dedicated virtual network domain based on user input.

As an embodiment, the computing system 100 may receive input for creating a customer-dedicated virtual network domain through a user console screen accessed from a user terminal 10.

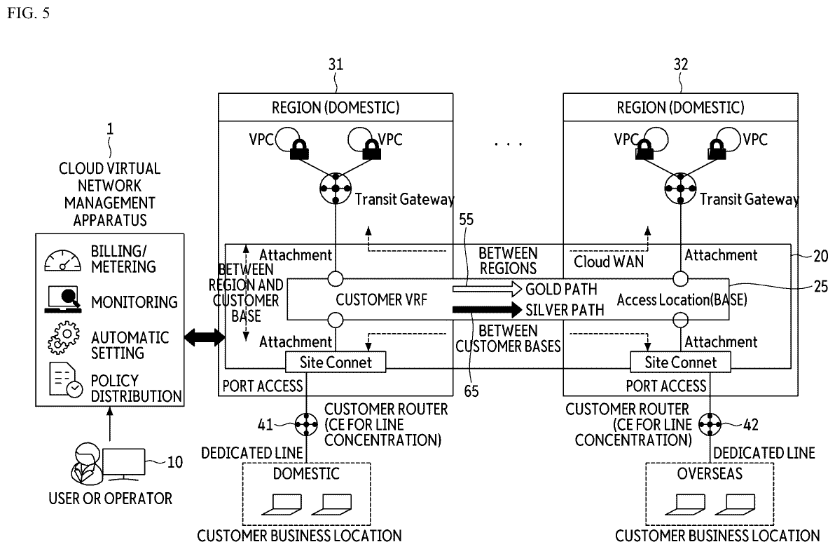

As an example, referring to FIG. 5, a user or operator may create a name of a customer-dedicated cloud virtual network (CloudWAN) 20 through a user console screen and then input a name of a segment in a service menu to create one customer-dedicated virtual network domain (VRF) 25 corresponding to the name of the segment in network equipment.

In addition, if a region to which the customer-dedicated virtual network domain is to be applied is selected through the user console screen, the customer-dedicated virtual network domain may be applied to equipment in the region. Here, since there are multiple regions to which the customer-dedicated virtual network domain is to be applied depending on the status of global bases, the regions may be selected from a list of bases. For example, referring to FIG. 5, base names of domestic and overseas cloud regions 31 and 32 to be used by a customer or names of pieces of equipment located in the regions 31 and 32 may be selected.

Next, in operation S20, the computing system 100 sets a multi-transmission path policy for the customer-dedicated virtual network domain based on user input.

As an embodiment, the computing system 100 may set a transmission path for each application for the customer-dedicated virtual network domain based on user input. Here, the transmission path may be configured as a line of different quality depending on at least one of a dedicated optical cable, a dedicated line, an Internet line, speed, duplexing, and a telecommunications service provider.

As an example, as illustrated in FIG. 5, a gold path 55 and a silver path 56 may be set as transmission paths applicable to each application for the customer-dedicated virtual network domain 25. Here, the gold path 55 may be configured as a dedicated optical cable line, and the silver path 56 may be configured as a dedicated service line of a telecommunications service provider. As another example, a bronze path (not illustrated) may be additionally used as a multi-transmission path, in addition to the gold path 55 and the silver path 56. The bronze path may be configured as an Internet line of a telecommunications service provider.

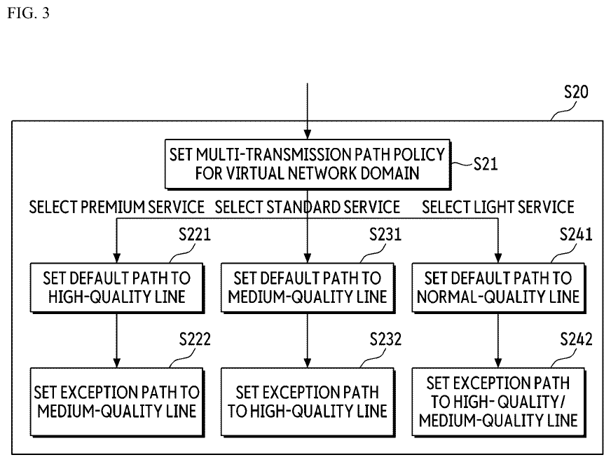

As an embodiment, referring to FIG. 3, when the computing system 100 sets the multi-transmission path policy for the customer-dedicated virtual network domain, any one of a plurality of service contract types may be selected based on user input in operation S21.

Here, if ‘premium service’ is selected as a service contract type, the computing system 100 may set a default path to a high-quality line in operation S221 and set an exception path to a medium-quality line in operation S222. As an example, in the case of ‘premium service’, a transmission path for internal business traffic such as ERP may use a high-priced, high-quality network path, and a low-priced, low-quality network path may be used only for accessing Internet websites. Therefore, a specialized service that can reduce costs can be provided.

In addition, if ‘standard service’ is selected as a service contract type, the computing system 100 may set the default path to a medium-quality line in operation S231 and set the exception path to a high-quality line in operation S232. As an example, in the case of ‘standard service’, even if a basic traffic transmission path uses a low-quality network path, quality-critical services such as some Internet telephony and video conferencing may be sent through a guaranteed high-quality network path. Therefore, a differentiated service with guaranteed quality can be provided.

In addition, if ‘light service’ is selected as a service contract type, the computing system 100 may set the default path to a normal-quality line in operation S241 and set the exception path to a high-quality or medium-quality line in operation S242.

In an embodiment, the high-quality line may be a dedicated optical cable line, the medium-quality line may be a dedicated line of a telecommunications service provider, and the normal-quality line may be an Internet line of a telecommunications service provider.

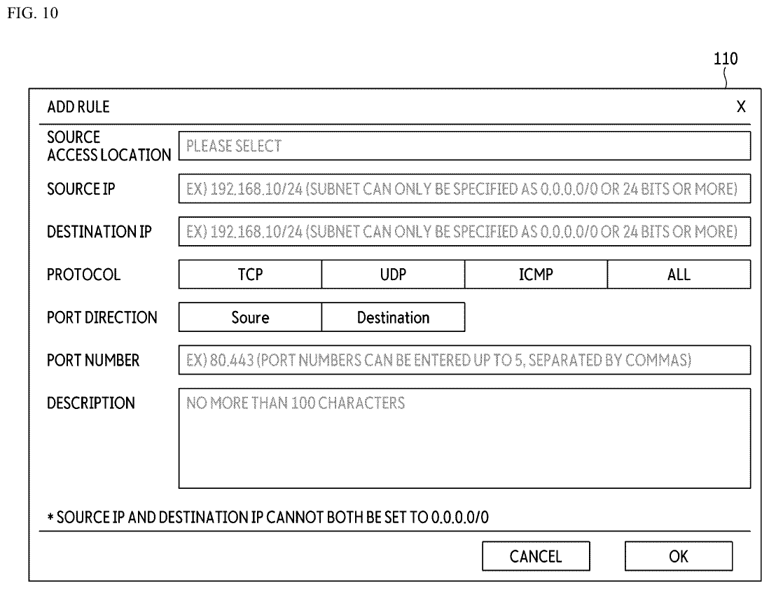

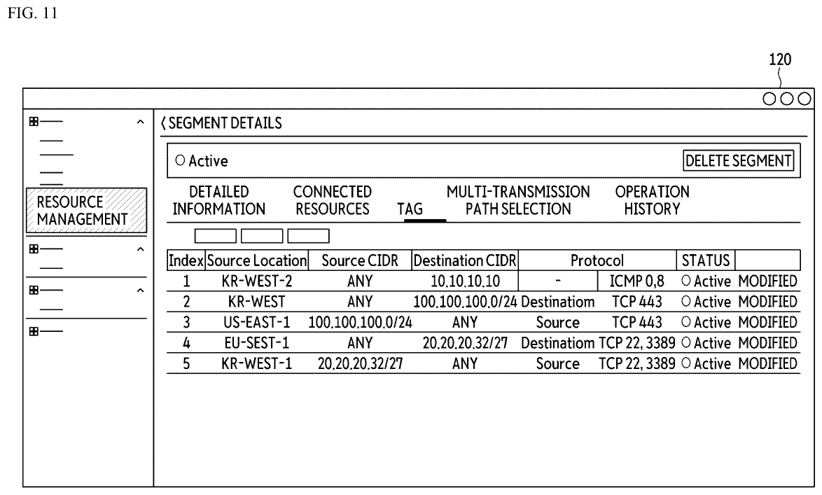

As an embodiment, the default path may be automatically set using line information preset for the selected service contract type, and the exception path may be set based on input for selecting at least one of source IP information, destination IP information, port information, protocol type, and location information of an application, as in a rule input screen 110 of the exception path of the multi-transmission path policy illustrated in FIG. 10. At this time, as illustrated in FIG. 11, a segment detail screen 120 which displays a rule list of the exception path which is input through the rule input screen 110 of FIG. 10 may be provided. Here, the segment detail screen 120 may display the entire rule list of the exception path which is set for a segment corresponding to a service name of the customer-dedicated virtual network domain (VRF). The rule list of the exception path applied to the segment can all be deleted by selecting a ‘Delete Segment’ button at the upper right of the screen.

Referring back to FIG. 2, in operation S30, the computing system 100 completes the service configuration of the customer-dedicated virtual network domain by specifying a section to which the multi-transmission path policy is to be applied. Here, the section may be customer sites or customer equipment of a source (region) and a destination (region) to which the multi-transmission path policy of the customer-dedicated virtual network domain is applied and network configuration equipment directly connected to the customer sites or the customer equipment.

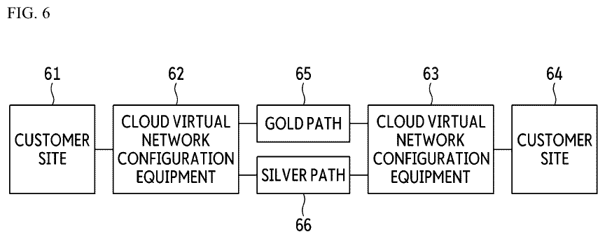

As an example, referring to FIG. 6, in order to apply a policy of setting a gold path 65 or a silver path 66 according to the type of line for each application on the customer-dedicated virtual network domain 25, network configuration equipment 62 and 63 of source and destination regions to which the policy is to be applied and customer sites 61 and 64 connected to the network configuration equipment 62 and 63 may be specified.

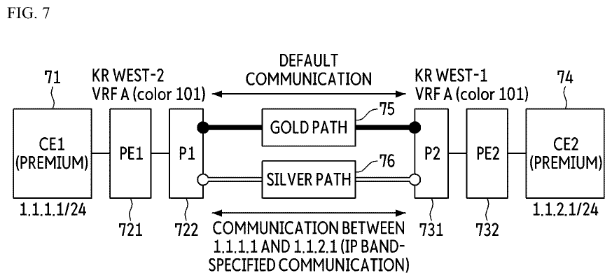

In an example illustrated in FIG. 7, PE1 721 and PE2 732 are network service edge equipment to which customer equipment is directly connected, and P1 722 and P2 731 are network service backbone equipment to which transmission lines are connected. CE1 71 and CE2 74 are customer site equipment and are structured such that customer sites of a KR WEST-2 region and a KR WEST-1 region are connected through a network service backbone.

Here, the computing system 100 may set equipment in the following order in order to provide a multi-transmission path service.

First, a user may create one customer-dedicated virtual network domain (VRF) corresponding to a name of a segment in network equipment by inputting the name of the segment through a console screen and may set a policy of automatically setting a default path. Here, in the example of FIG. 7, the customer-dedicated virtual network domain is named VRF A, and the transmission path policy is named ‘color 101’.

Next, a premium service or a standard service may be selected as a service contract type, and a default path and an exception path of a multi-transmission path to be applied to the selected service contract type may be input. At this time, if the user specifies a region or equipment to which the policy needs to be applied, the default path may be applied to the PE1 equipment 721 at the corresponding location. The exception path may be applied by checking IP information of a destination and location information of the PE2 equipment 732 connected to the destination and inputting the IP of the destination to the PE2 equipment 732. Here, the exception path may also be set by inputting IP information of a source, port information, and protocol information together with the IP information of the destination.

Finally, the setting may be completed by applying a policy rule to interfaces of the PE equipment 721 and 732 to which the customer CE equipment 71 and 74 is connected.

According to the above embodiment, when transmitting user traffic on a network, a user can easily set a multi-transmission path policy for a customer-dedicated virtual network domain only by setting software through a console screen without physical network separation.

Accordingly, it is possible to apply a different line to each application based on importance and priority, rather than uniformly applying only one type of line to a virtual network domain. Consequently, this can increase efficiency in terms of speed and cost of traffic transmission.

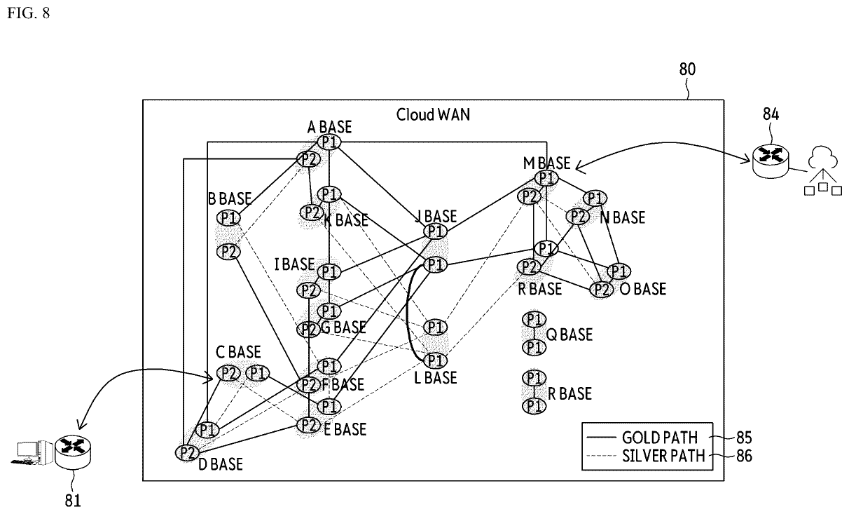

FIG. 8 is an example of transmitting traffic using a different transmission path for each application according to embodiments of the present disclosure. Referring to FIG. 8, after a gold path 85 and a silver path 86, which are transmission paths of user traffic, are set for a customer's VRF created on Cloud WAN 80 which is a virtual cloud network, they may be connected to equipment 81 and 84 at customer sites.

In the illustrated example, the gold path 85 may be set as a default path, and a high-quality line such as a dedicated optical cable may be applied. For example, the gold path 85 may be applied to a line from C base->E base->J base->M base, which is a path through which traffic of an ERP system is transmitted.

The silver path 86 may be set as an exception path, and a medium-quality line such as a dedicated line of a telecommunications service provider may be applied. For example, the silver path 86 may be applied to a line from C base->E base->L base->P base->M base, which is a path through which traffic other than that of the ERP system is transmitted.

As described above, when a multi-transmission path policy is applied to a cloud virtual network according to an embodiment of the present disclosure, a high-quality line may be applied to transmit traffic of a business system that requires high speed and quality, and a medium-quality line may be applied to transmit traffic of other business systems. Accordingly, this can increase efficiency in terms of cost while increasing user satisfaction.

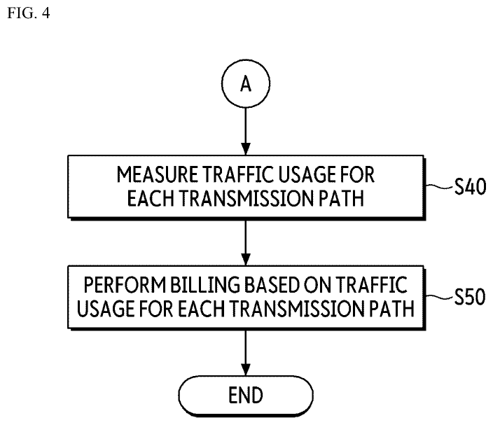

Operations additionally performed after the operations illustrated in FIG. 2 will now be described using FIG. 4.

Referring to FIG. 4, the computing system 100 may additionally perform operations S40 and S50 after performing operations S10 through S30 described in FIG. 2.

In operation S40, the computing system 100 may measure the usage of traffic for each transmission path or region transmitted according to the multi-transmission path policy set for the virtual network domain.

As an embodiment, a value of the traffic usage may be measured by a usage collection device or a usage collection module included in the computing system 100. Here, the usage collection device or the usage collection module may periodically collect the usage from network equipment through a simple network management protocol (SNMP) query. The usage may also be collected using a telemetry technique that automatically measures the status of remote locations, instead of the SNMP query.

Next, in operation S50, the computing system 100 may perform billing based on the traffic usage measured for each transmission path or region.

As an embodiment, the computing system 100 may store information about the traffic usage for each transmission path or region measured in operation S40 above and, when a user selects a transmission path or a region through a console screen, may transmit the usage of the transmission path or the region and fee information values corresponding to the usage so that the user can check the cost.

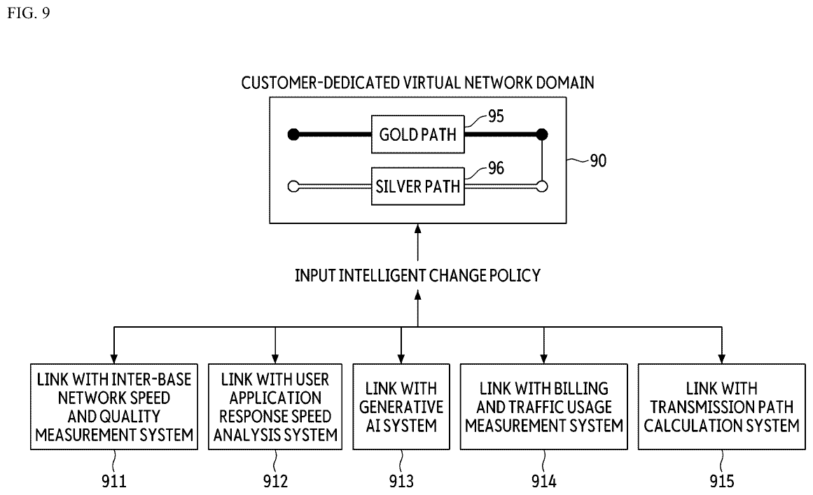

FIG. 9 is an example of applying an intelligent transmission path change policy based on traffic usage and service quality according to embodiments of the present disclosure.

Referring to FIG. 9, as an embodiment, when setting a multi-transmission path policy for a customer-dedicated virtual network domain 90, the computing system 100 may apply an intelligent change policy according to a preset policy model.

As an embodiment, the computing system 100 may set a gold path 95 and a silver path 96 using a method 911 of linking with an inter-base network speed and quality measurement system.

As an example, the computing system 100 may set a line applied to each transmission path by time based on the usage of traffic transmitted through each transmission path by time. For example, a time-based policy may be applied to set the gold path 95 during a daytime when traffic is high and set the silver path 96 with low usage fees during nighttime non-business hours when traffic is low.

As another example, the computing system 100 may set a detour to a second base with low traffic usage to be made in response to traffic usage increasing to or above a threshold at a first base on each transmission path. For example, a base quality-based policy may be created and applied to detour to a path to a base with low traffic if detecting that traffic is concentrated at a specific base while continuously measuring inter-base network speed.

In addition, the computing system 100 may set a detour to a fourth base, which is safe from security attacks, to be made in response to a security attack being detected at a third base on each transmission path. For example, the transmission path can be automatically changed using this method when a security attack such as DDoS occurs.

As an embodiment, the computing system 100 may set the gold path 95 and the silver path 96 using a method 912 of linking with a user application response speed analysis system.

As an example, the computing system 100 may set a line applied to a specific application to be automatically changed in response to the response speed of the specific application being detected to be equal to or lower than a preset reference value. For example, an application quality-based policy may be applied to automatically adjust only a specific application used by a customer to the gold path 95 if the response speed of the specific application is slow.

As an embodiment, the computing system 100 may set the gold path 95 and the silver path 96 using a method 913 of linking with a generative AI system.

As an example, the computing system 100 may extract location information, IP information and port information of a specific application based on a generative AI model using service analysis data associated with the specific application and may automatically create an input rule for setting a transmission path of the specific application using the extracted information. For example, if a user requests an AI system to apply an input rule to a specific application without manually inputting the IP, port and location of the application, an AI-based input policy may be applied to create an input rule by automatically extracting the IP information, port, location, etc. of the application by linking with a separate service analysis system.

As an embodiment, the computing system 100 may set the gold path 95 and the silver path 96 using a method 914 of linking with a billing and traffic usage measurement system.

As an example, the computing system 100 may create a rule based on an AI model to delete a first transmission path and use a second transmission path in response to traffic usage for the first transmission path applied to a specific application exceeding a preset upper limit. For example, in a situation where a user contracts a premium service and uses the gold path 95 by default and the less expensive silver path 96 for some traffic, a usage cap policy may be applied. In the usage cap policy, an upper limit may be set so that a customer can use the silver path 96 only for an appropriate level of traffic. If traffic usage measured by a billing system exceeds the upper limit, a rule deletion policy may be automatically created through an AI system to delete the silver path 96 and use only the gold path 95.

As an embodiment, the computing system 100 may set the gold path 95 and the silver path 96 using a method 915 of linking with a transmission path calculation system.

As an example, the computing system 100 may calculate a shortest path for a specific application and reset a transmission path in response to a failure of at least one of a base, equipment, and line of the transmission path applied to the specific application. For example, a policy that uses a transmission path of a more efficient line by recalculating the shortest path rather than simply detouring to a backup path in the event of a failure of a base, equipment, or a line may be applied.

According to the embodiment of the present disclosure described above, when configuring a virtual network domain (VRF) for each customer or purpose on a cloud virtual network, it is possible to configure an intelligent multi-transmission path policy based on automatic settings or an AI model using traffic usage and application quality.

FIG. 12 is a hardware configuration diagram of an exemplary computing system 100.

Referring to FIG. 12, the computing system 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing system 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing system 100. The bus 107 may be implemented as various types of bus such as an address bus, a data bus and a control bus.

The network interface 102 supports wired and wireless internet communication of the computing system 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

In some embodiments, the computing system 100 described with reference to FIG. 12 may be configured using one or more physical servers included in a server farm based on cloud technology such as a virtual machine. In this case, at least some of the components illustrated in FIG. 12, such as a processor 101, a memory 103 and a storage 104, may be virtual hardware, and a network interface 102 may be configured as a virtualized networking element such as a virtual switch.

As an embodiment, the computer program 105 may include instructions for performing an operation of creating a customer-dedicated virtual network domain based on user input, an operation of setting a multi-transmission path policy for the virtual network domain, and an operation of completing service configuration of the virtual network domain by specifying a section to which the multi-transmission path policy is to be applied.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method of providing a multi-transmission path service on a cloud virtual network, the method being performed by a computing system and comprising:
creating a customer-dedicated virtual network domain based on user input;
setting a multi-transmission path policy for the virtual network domain; and
completing service configuration of the virtual network domain by specifying a section to which the multi-transmission path policy is to be applied.

2. The method of claim 1, wherein the creating of the customer-dedicated virtual network domain comprises receiving input for selecting a region to which the virtual network domain is to be applied.

3. The method of claim 1, wherein the setting of the multi-transmission path policy for the virtual network domain comprises setting a transmission path for each application for the virtual network domain.

4. The method of claim 3, wherein the transmission path is configured as a line of a different quality depending on at least one of a dedicated line, an Internet line, a speed, a duplexing, and a telecommunications service provider.

5. The method of claim 1, wherein the setting of the multi-transmission path policy for the virtual network domain comprises:
selecting any one of a plurality of service contract types for the virtual network domain; and
setting a default path to a high-quality line and setting an exception path to a medium-quality line if the selected service contract type is a premium service.

6. The method of claim 1, wherein the setting of the multi-transmission path policy for the virtual network domain comprises:
selecting any one of a plurality of service contract types for the virtual network domain; and
setting a default path to a medium-quality line and setting an exception path to a high-quality line if the selected service contract type is a standard service.

7. The method of claim 1, wherein the setting of the multi-transmission path policy for the virtual network domain comprises:
selecting any one of a plurality of service contract types for the virtual network domain; and
setting a default path to a normal-quality line and setting an exception path to a high-quality line or a medium-quality line if the selected service contract type is a light service.

8. The method of claim 5, wherein the default path is automatically set using line information preset for the selected service contract type, and the exception path is set based on input for selecting at least one of source IP information, destination IP information, port information, protocol type, and location information of an application.

9. The method of claim 7, wherein the high-quality line is a dedicated optical cable, the medium-quality line is a dedicated line of a telecommunications service provider, and the normal-quality line is an Internet line of a telecommunications service provider.

10. The method of claim 1, further comprising measuring a usage of traffic for each transmission path transmitted according to the multi-transmission path policy set for the virtual network domain.

11. The method of claim 10, further comprising performing billing based on the usage of traffic measured for each transmission path.

12. The method of claim 1, wherein the setting of the multi-transmission path policy for the virtual network domain comprises setting a line applied to each transmission path by time based on a usage of traffic transmitted through each transmission path by time.

13. The method of claim 1, wherein the setting of the multi-transmission path policy for the virtual network domain comprises setting a detour to a second base with a low traffic usage to be made in response to a traffic usage increasing to or above a threshold at a first base on each transmission path.

14. The method of claim 1, wherein the setting of the multi-transmission path policy for the virtual network domain comprises setting a detour to a fourth base, which is safe from a security attack, to be made in response to the security attack being detected at a third base on each transmission path.

15. The method of claim 1, wherein the setting of the multi-transmission path policy for the virtual network domain comprises setting a line applied to a specific application to be automatically changed in response to a response speed of the specific application being detected to be equal to or lower than a preset reference value.

16. The method of claim 1, wherein the setting of the multi-transmission path policy for the virtual network domain comprises:
extracting location information, IP information and port information of a specific application based on a generative AI model using service analysis data associated with the specific application; and
creating an input rule for setting a transmission path of the specific application using the extracted information.

17. The method of claim 1, wherein the setting of the multi-transmission path policy for the virtual network domain comprises creating a rule based on an AI model to delete a first transmission path and use a second transmission path in response to traffic usage for the first transmission path applied to a specific application exceeding a preset upper limit.

18. The method of claim 1, wherein the setting of the multi-transmission path policy for the virtual network domain comprises calculating a shortest path for a specific application and resetting a transmission path in response to a failure of at least one of a base, equipment, and line of the transmission path applied to the specific application.

19. A cloud virtual network management apparatus comprising:
one or more processors;
a memory loading a computer program to be executed by the one or more processors; and
a storage storing the computer program,
wherein the computer program comprises instructions for performing an operation of creating a customer-dedicated virtual network domain based on user input, an operation of setting a multi-transmission path policy for the virtual network domain, and an operation of completing service configuration of the virtual network domain by specifying a section to which the multi-transmission path policy is to be applied.

20. The apparatus of claim 19, wherein the operation of setting the multi-transmission path policy for the virtual network domain comprises an operation of setting a transmission path for each application for the virtual network domain, and the transmission path is configured as a line of a different quality depending on at least one of a dedicated line, an Internet line, speed, duplexing, and a telecommunications service provider.
